(19) United States
(12) Patent Application Publication
(10) Pub. No.: US 2010/0087093 A1
(43) Pub. Date: Apr. 8, 2010

(54) CONNECTOR FOR ADAPTING ADAPTORS OF VARIOUS PROTOCOLS

(75) Inventors: Mei-Chuan Yu, Banciao (TW); Tien-Fu Cheng, Banciao (TW); Shou-Yi Chen, Banciao (TW)

Correspondence Address: T-CONN PRECISION CORP., P.O. BOX 11192, TAIPEI, 10099, TW

(73) Assignee: T-CONN PRECISION CORPORATION, BANCIAO (TW)

(21) Appl. No.: 12/245,737

(22) Filed: Oct. 4, 2008

(51) Int. Cl. H01R 13/648

(52) U.S. Cl. 439/607.01

(57) ABSTRACT

A connector adaptor suitable for various transmission protocols is disclosed. The connector includes a hollow case, two positioning sets, two terminal sets. The two positioning sets are formed on the upper side and a lower side of said hollow case. The two terminal sets are connected to the positioning sets respectively, and said terminal sets are respectively connected to a flat face of said positioning set for an electrical connection. The hollow case is made in a plastic injection process.

### BACKGROUND OF THE INVENTION

1. Field of the Invention

The present invention relates to a connector, and more particularly to a connector for adapting adaptors of various protocols.

2. Description of Related Art

In the revolution of the digital technology era, nowadays transmission of electronic information can be processed via internet, and also by connecting a connector to an adaptor, the electronic information may be transmitted to another electronic appliance. Thus, it is possible to effectively transfer the information between the electronic appliances.

There are several types of connectors with various specifications, mono spec connector has to adapt to a corresponding connector for electrically connecting and transferring information. The most popularly used connecting device applied in the peripheral device for external connection to a computer is the universal serial bus (USB). Although the cost is lower, however, the defect of the USB is limited by the transmission speed. Along with the increasing volume of computer information, whose unit is Gb, the eSATA (external serial advanced technology attachment) is applied for processing connection for the high speed information transmission, and thereby upgrade the transmission speed. The above two transmission specifications still have its own application purpose.

However, the transmission interfaces of the USB and eSATA are not compatible with each other. Taking the connector adaptor as an example, it comprises two hollow cases with a positioning set therein. The positioning set is connected to a plurality of metallic terminals. The latest computers mostly have the USB connector adaptor or eSATA connector adaptor. For more convenience and higher volume information processing, the future computers should be equipped with the connector adaptor with both specifications.

Accordingly, the present invention provides a connector adaptor including terminals in the various protocols for complying with different protocol specifications.

### SUMMARY OF THE INVENTION

The present invention provides a connector adaptor capable of being applied in the various protocols, and also reduce the possibility of error occurring due to being plugged into a wrong adaptor.

In accordance with above purpose, the present invention provides a connector adaptor complying with various protocols, which comprises a hollow case formed by a plastic injection process, and therefore can hollow case can be formed as a single piece. The hollow case comprises a fool-proof device and is connected to a positioning set via an upper side and a lower side respectively. The positioning set comprises a terminal set, and the hollow case is covered by a housing.

The hollow case comprises a clamping portion at the bottom thereof for steadily assembling the hollow case with the housing. The positioning set extends from the upper and the lower sides in the hollow case respectively and connects to a terminal set of various transmission specifications to form a plurality of passages between the positioning set and the hollow case, and thereby steadily and securely adapt the connector in the case.

Accordingly, the present invention provides a single connector adaptor complying with various protocols to enable the user to easily and securely connect in the direction of the connection.

### BRIEF DESCRIPTION OF THE DRAWING

For a more complete understanding of the present invention, reference will now be made to the following detailed description of preferred embodiments taken in conjunction with the following accompanying drawings.

FIG. 1A is a front view of a hollow case according to a first embodiment of the present invention.

FIG. 1B is a front view of a hollow case according to a second embodiment of the present invention.

FIG. 2A is a perspective view according to the first embodiment of the present invention.

FIG. 2B is a perspective view according to the second embodiment of the present invention.

FIG. 3A is a view illustrating an assembly of the first embodiment of the present invention.

FIG. 3B is a view illustrating an assembly of the second embodiment of the present invention.

FIG. 4 is a sectional side view of the connector adaptor with a USB connector according to an embodiment of the present invention.

FIG. 5 is another aspect of the connector adaptor with a USB connector according to an embodiment of the present invention.

FIG. 6 is an aspect of an assembly of the connector adaptor with a USB connector according to an embodiment of the present invention.

FIG. 7 is a sectional side view of the connector adaptor with an eSATA connector according to an embodiment of the present invention.

FIG. 8 is another aspect of the connector adaptor with an eSATA connector according to an embodiment of the present invention.

FIG. 9 is an aspect of an assembly of the connector adaptor with an eSATA connector according to an embodiment of the present invention.

FIG. 10A is a front view of a third embodiment of the present invention.

FIG. 10B is a front view of a fourth embodiment of the present invention.

FIG. 10C is a front view of a fifth embodiment of the present invention.

FIG. 10D is a front view of a sixth embodiment of the present invention.

FIG. 10E is a front view of a seventh embodiment of the present invention.

FIG. 10F is a front view of a eighth embodiment of the present invention.

### DETAIL DESCRIPTION OF THE INVENTION

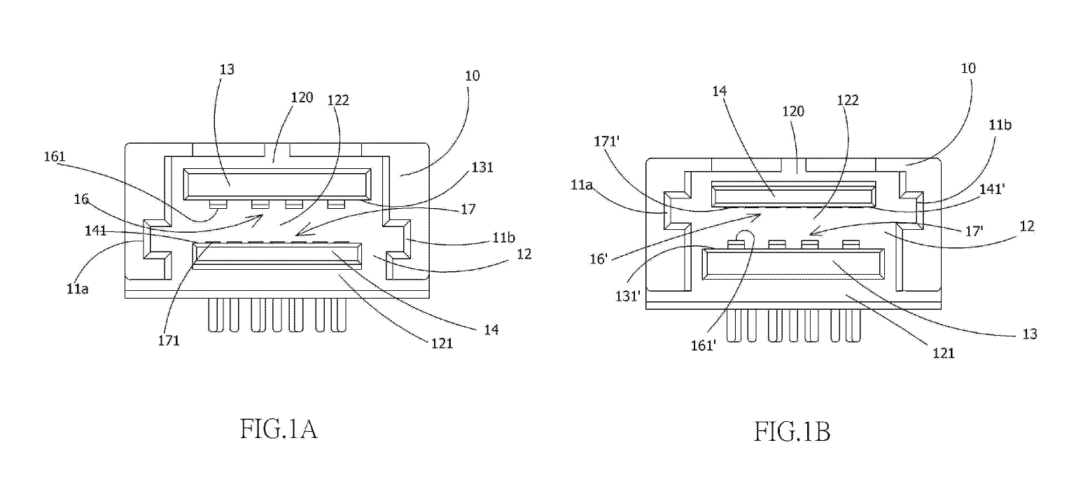

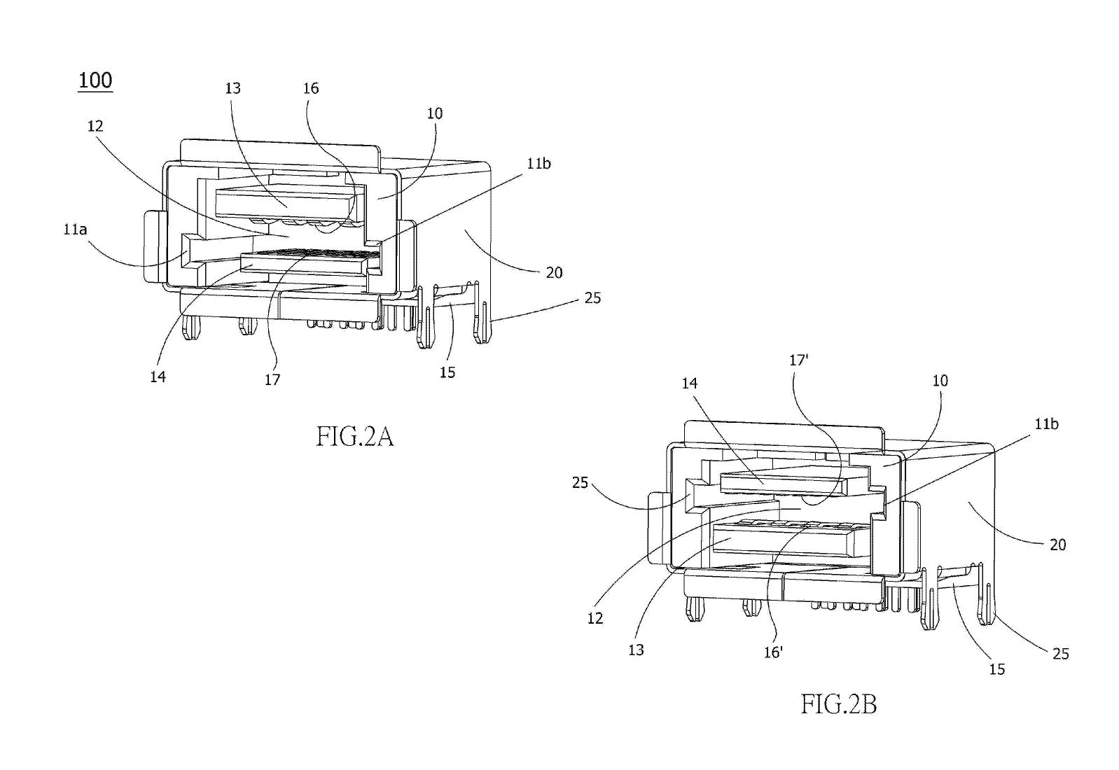

Referring to FIG. 1A and 2A, a front view and a perspective view according to the first embodiment of the present invention are illustrated. The connector adaptor 100 of the present invention comprises a hollow case 10 and a housing 20. The hollow case 10 is formed by a plastic injection process, and comprises two fool-proof grooves 11a and 11b, a hollow portion 12, a first positioning set 13, a second positioning set 14, a clamping portion 15 (as illustrated in FIG. 2A), a USB terminal set 16 and an eSATA terminal set 17. The two fool proof grooves 11a and 11b are respectively formed at the two lower sides of the hollow case 10. The hollow case 10 comprises a hollow portion 12 including a first positioning set 13 and a second positioning set 14 respectively formed on the inner upper and lower sides thereof to form a first space 120 between the top side of the first positioning set 13 and the hollow case 10, a second space 121 between the bottom side of the second positioning set 14 and the hollow case 10, and a space 122 between the first and second positioning sets 13 and 14.

The positioning set 13 is an extension of the hollow case 10 and is integrally formed with the hollow case 10. A flat face 131 beneath the first positioning set 13 comprises a plurality of USB terminal sets 16 including hook-shaped movable USB terminals 161. A flat face 141 above the second positioning set 14 comprises a plurality of eSATA terminal sets 17 having a plurality of flat fixed eSATA terminals 171.

Referring to FIGS. 1B and 2B, a front view and a perspective view according to the second embodiment of the present invention is illustrated. The hollow case 10 is formed by a plastic injection process, and comprises two fool-proof grooves 11a and 11b, a hollow portion 12, a first positioning set 13, a second positioning set 14, a clamping portion 15 (as illustrated in FIG. 2B), a USB terminal set 16 and an eSATA terminal set 17. The two fool proof grooves 11a and 11b are respectively formed in the hollow case 10 at the two lower sides thereof. The hollow case 10 comprises a hollow portion 12 including a first positioning set 13 and a second positioning set 14 respectively on the inner upper and lower sides.

The hollow portion 12 comprises a first space 120, a second space 121, a third space 122, the first positioning set 13 and the second positioning set 14. The first space 120 is formed between a top side of the second positioning set 14 and the hollow case 10, the second space 121 is formed between a bottom side of the first positioning set 13 and the hollow case 10, and the space 122 is formed between the first and the second positioning sets 13 and 14.

The eSATA terminal sets 17 is connected to the flat face 141 beneath the second positioning set 14 and comprises a flat fixed eSATA terminals 171. The USB terminal set 16 is connected to the flat face 131 above the first positioning set 13 comprises a plurality of USB terminal sets 16 having a hook-shaped movable USB.

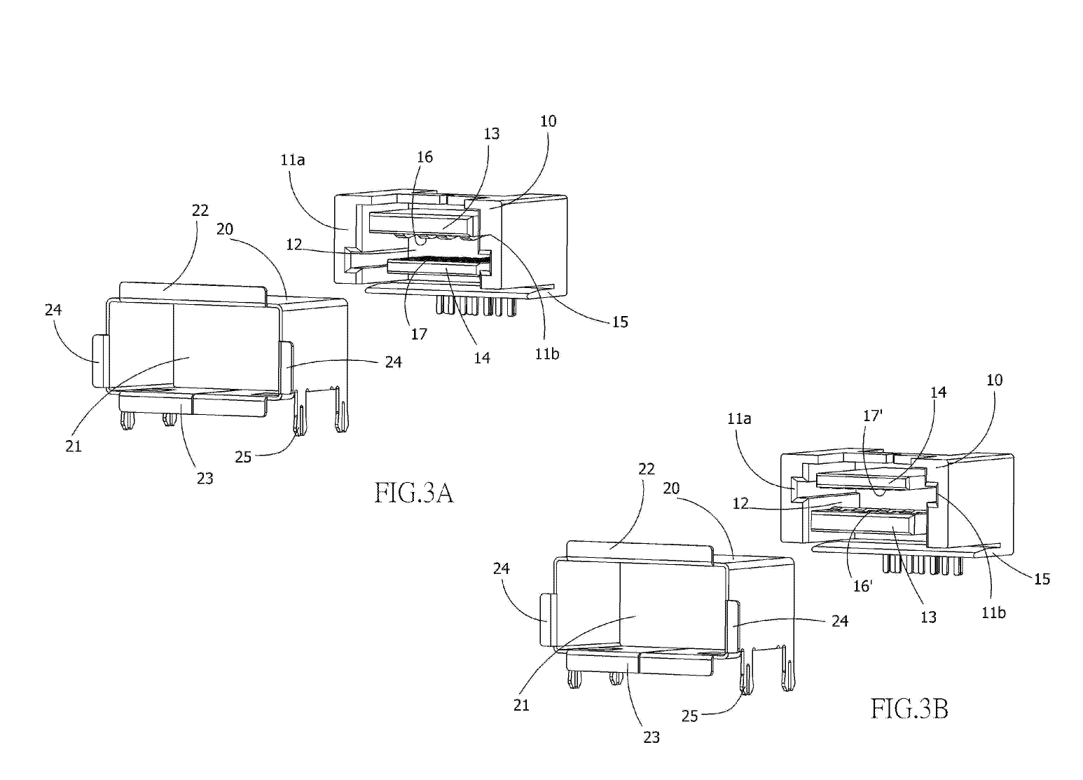

Referring to FIG. 3A, the housing 20 is a one-piece metallic case fabricated from a stamping process, and may be comprised of iron. The housing 20 comprises a hollow portion 21, an upper stopper 22, a low stopper 23, two short stoppers 24 and a plurality of pins 25. The hollow portion 21 of the housing 20 passes through the housing 20 fitting with hollow case 10. The clamping portion 15 at the bottom of the hollow case 10 can effectively and steadily joint the hollow case 10 with the housing 20 when the hollow case 10 fits into the housing 20.

Referring to FIG. 3B, the connector comprises the hollow case 10 formed by a plastic injection process and a housing 20 comprised of a metallic material and formed by a stamping process. In the present embodiment, the housing 20 is comprised of iron. The housing 20 comprises a hollow portion 21, an upper stopper 22, a low stopper 23, two short stoppers 24 and a plurality of pins 25. The hollow case 10 is fit into the housing 20 and the housing 20 is joined with the hollow case 10 by the clamping portion 15 to complete the assembly.

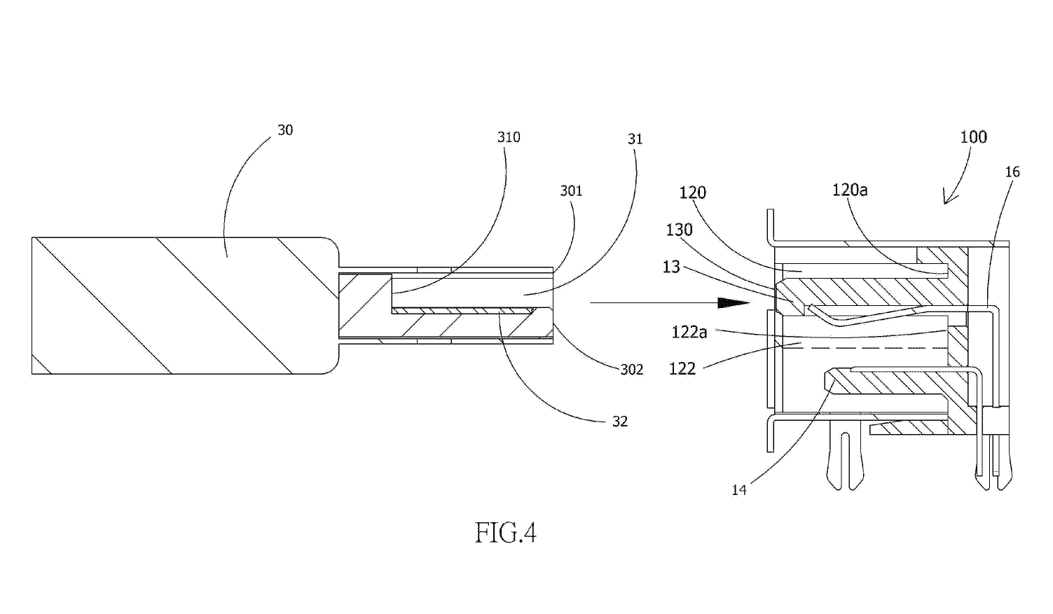

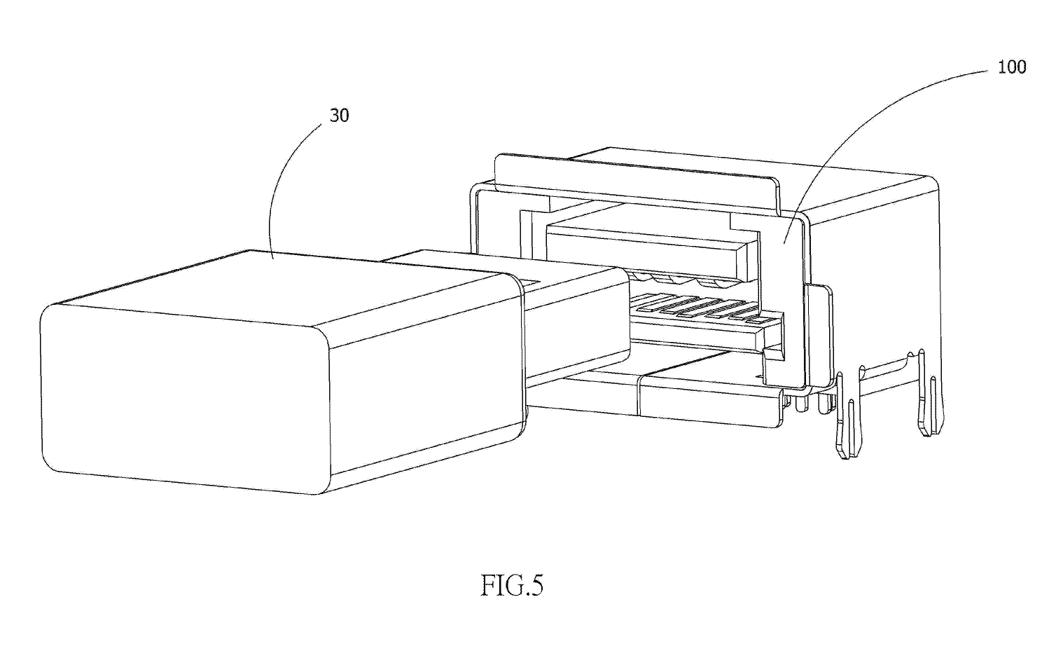

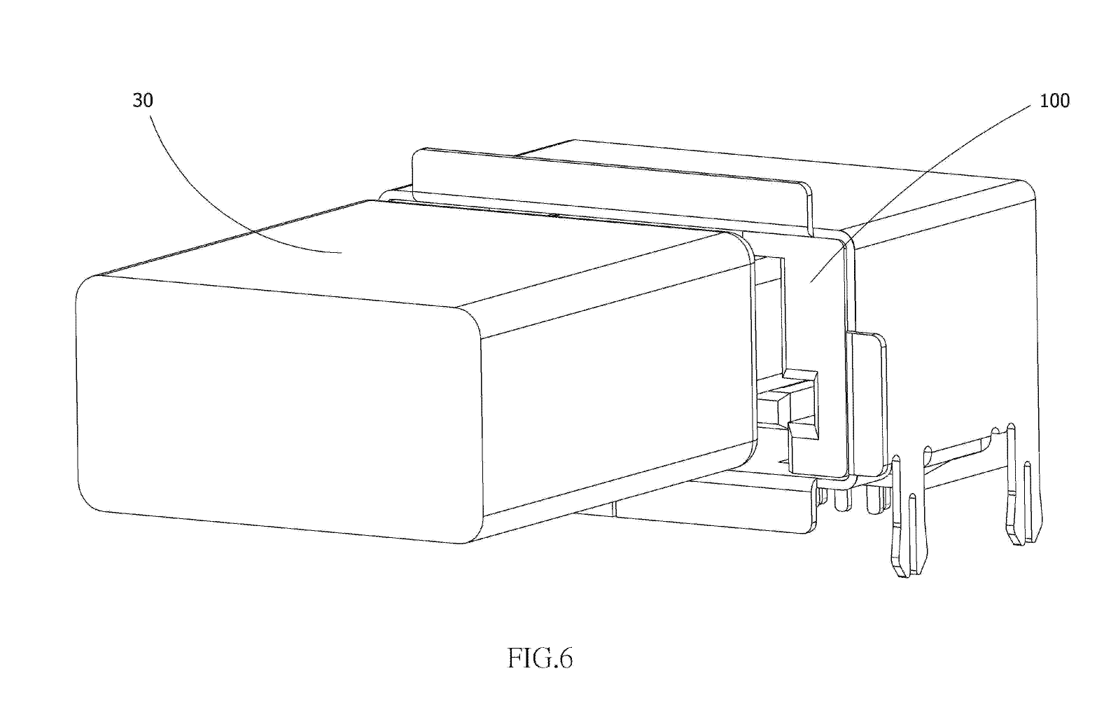

Referring to FIGS. 4 to 6, when the user connects the USB connector 30 to the connector adaptor 100, the USB connector 30 is directly plugged into the first positioning set 13 of the connector adaptor 100 to make a close contact between the U-shape hollow portion 31 of the USB connector 30 with the first positioning set 13, and the bottom side 310 of the U-shape hollow portion 31 of the USB connector 30 contacts the distal end 130 of the first connecting set 13. Meanwhile, the upper end 301 and the lower end 302 at the frontal end of the USB connector 30 are respectively connected to the bottom sidewall 120a of the first space 120 and the bottom top sidewall 122a of the space 122 beneath the first positioning set 13. Thus, the USB connector 30 is securely connected to the connector adaptor 100.

After plugging the USB connector into the connector adaptor 100, the terminals 32 in the USB connector 30 is directly connected to the USB terminal set 16 of the first positioning set 13 for electrical connection. The fool-proof device in the connector adaptor 100 can prevent wrong assembly and effectively transmit the information and conversion.

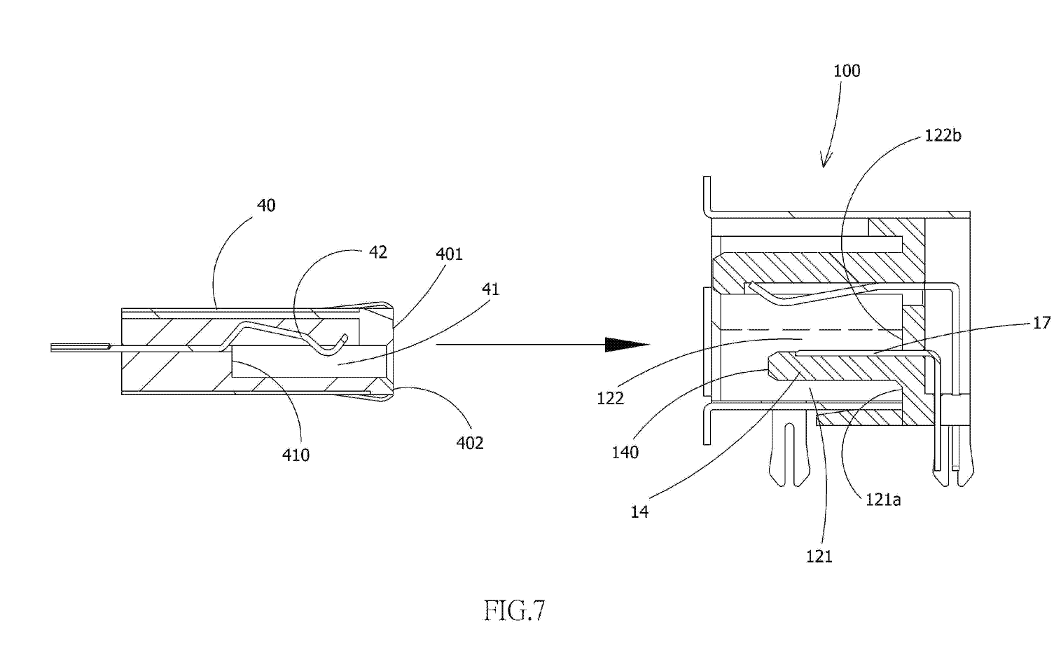

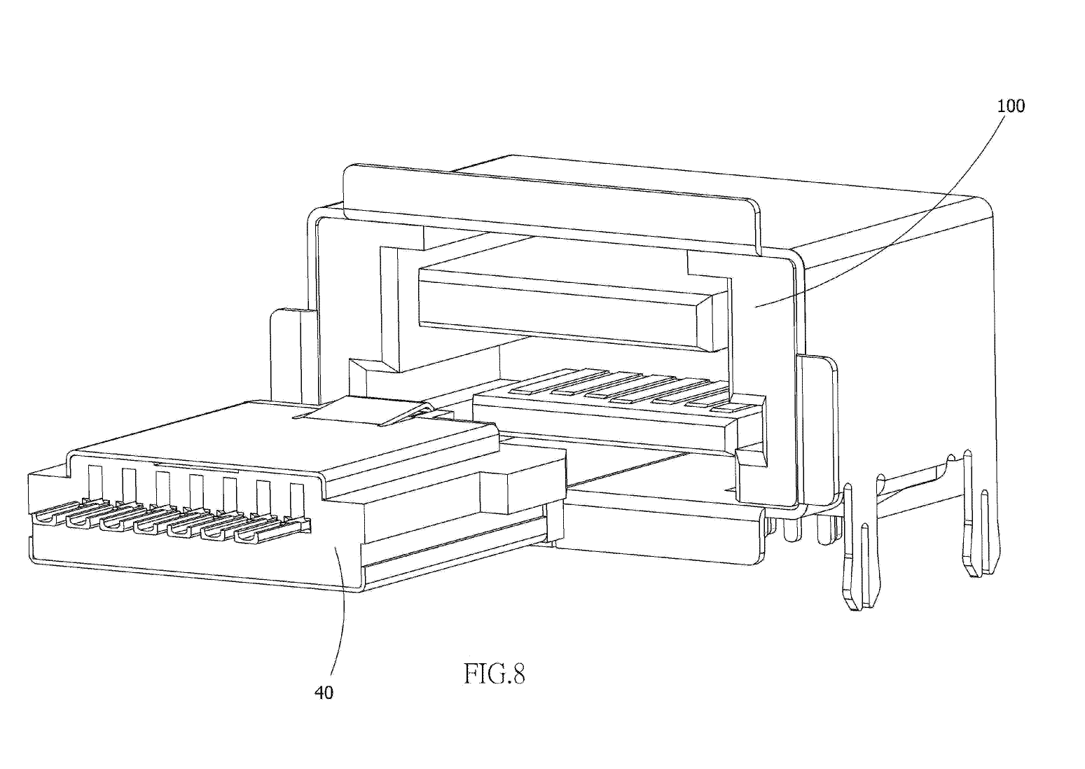

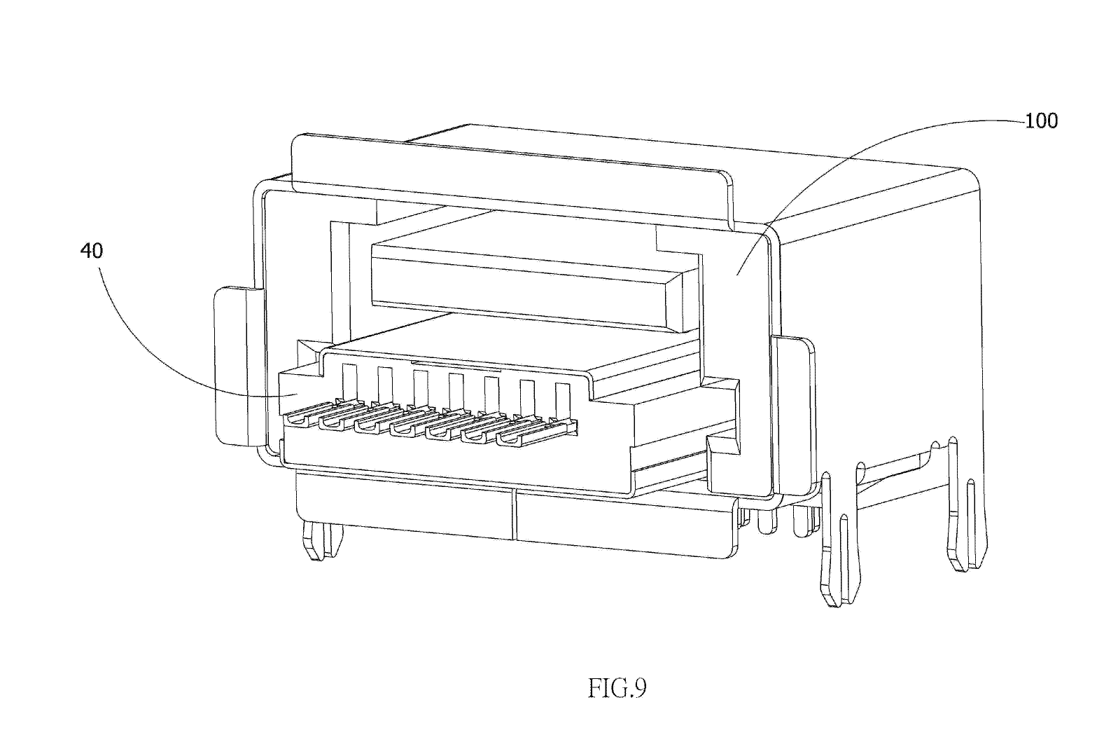

Referring to FIGS. 7 to 9, when the user plugs the eSATA connector 40 into the connector adaptor 100, the fool-proof device of the connector adaptor 100 enables the user to directly plug the eSATA connector 40 into the second positioning set 14 of the connector adaptor 100, and the U-shape hollow portion 41 formed in the eSATA connector 40 is tightly fitted into the frontal end 140 of the second positioning set 14. The upper end 401 and the lower end 402 at the frontal end of the eSATA connector 40 are respectively connected to the bottom sidewall 122b of the second space 122 above the second positioning set 14 and the bottom sidewall 121a of the second space 121 beneath the second positioning set 14. Thus, the terminals 42 of the eSATA connector 40 directly and tightly connected to the eSATA terminal set 17 of the second positioning set 14. Thus, the eSATA connector 40 closely and steadily connected to the connector adaptor 100 of the present invention.

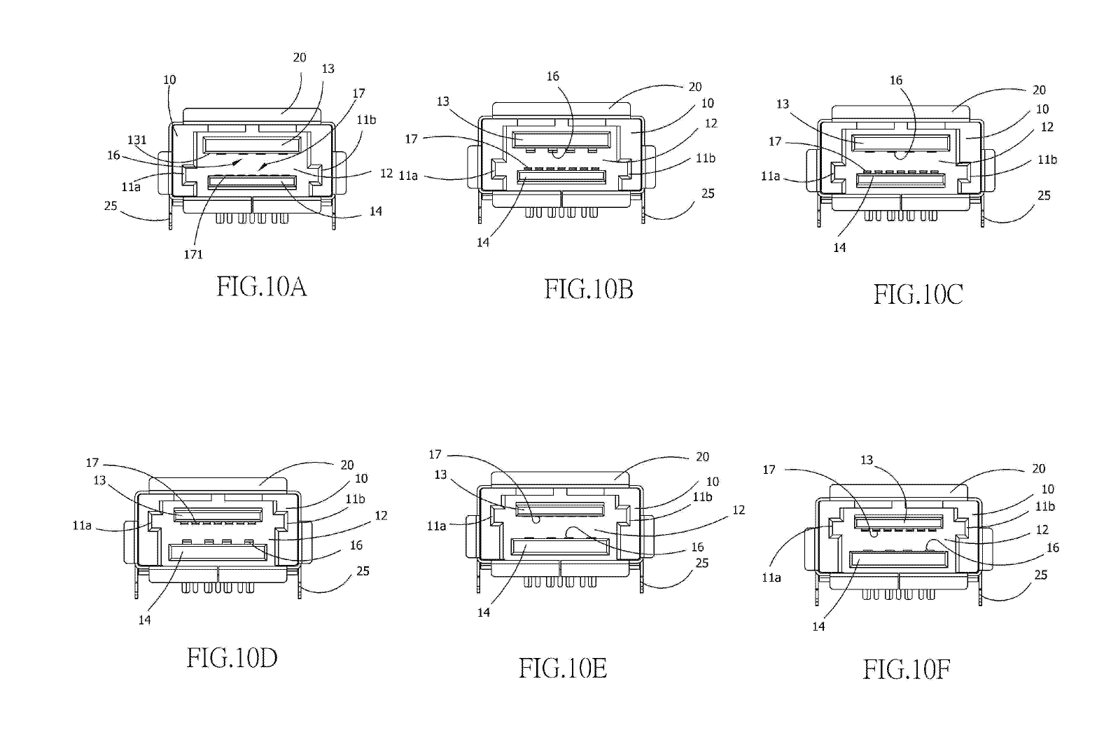

FIGS. 10A to 10C illustrate various embodiments of the present invention. The connector comprises a hollow case 10 formed by a plastic injection process and a housing 20. The hollow case 10 comprises two fool-proof grooves 11a and 11b, a hollow portion 12, a first positioning set 13, the second positioning set 14, a USB terminal set 16 and an eSATA terminal 17. As illustrated in FIG. 10A, the lower flat portion 131 beneath the first positioning set 13 is connected to the USB terminal set 16 including a plurality of fixed flat USB terminals 161. The upper flat portion 141 of the second positioning set 14 is connected to the eSATA terminal set 17 having a plurality of fixed flat eSATA terminals 171.

Referring to FIG. 10B, the lower flat portion 131 beneath the first positioning set 13 is connected to the USB terminal set 16 having a plurality of movable hook-like USB terminals 161. The upper flat portion 141 of the second positioning set 14 is connected to the eSATA terminal set 17 having a plurality of movable hook-like eSATA terminals 171.

Referring to FIG. 10B, the lower flat portion 131 beneath the first positioning set 13 is connected to the USB terminal set 16 having a plurality of fixed flat USB terminals 161. The upper flat portion 141 of the second positioning set 14 is connected to the eSATA terminal set 17 having a plurality of movable hook-like eSATA terminals 171.

Referring to FIGS. 10D to 10F, the connector comprises a hollow case 10 formed by a plastic injection process and a housing 20. The hollow case 10 comprises two fool-proof grooves 11a and 11b, a hollow portion 12, a first positioning set 13, the second positioning set 14, a USB terminal set 16 and an eSATA terminal 17. As illustrated in FIG. 10D, the lower flat portion 131 beneath the first positioning set 13 is connected to the eSATA terminal set 17 having a plurality of movable hook-like eSATA terminals 171. The upper flat portion 141 of the second positioning set 14 is connected to the USB terminal set 16 having a plurality of movable hook-like USB terminals 161.

Referring to FIG. 10E, the lower flat portion 131 beneath the first positioning set 13 is connected to the eSATA terminal set 17 having a plurality of fixed flat eSATA terminals 171. The upper flat portion 141 of the second positioning set 14 is connected to the USB terminal set 16 having a plurality of fixed flat USB terminals 161.

Referring to FIG. 10F, the lower flat portion 131 beneath the first positioning set 13 is connected to the eSATA terminal set 17 having a plurality of movable hook-like eSATA terminals 171. The upper flat portion 141 of the second positioning set 14 is connected to the USB terminal set 16 having a plurality of fixed flat USB terminals 161.

Accordingly, the present invention has at least the following advantages.

1. A single device comprises two different types of terminals can be applied to the connector adaptor with various transmission protocols for transmitting signals of connector terminals in different transmission specifications.

2. A single connector adaptor provides two different transmission protocols, thus the space occupation and manufacturing cost can be reduced and is more convenient to use.

3. The fool-proof design can substantially prevent wrong assembly of the connector and the adaptor.

4. The space in the case can effectively improve the connection between the connector and the adaptor, as well as increase stability of the electrical connection and transmission efficiency.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

1. A connector adaptor suitable for various transmission protocols, comprising
a hollow case;
a first positioning set extending from an inner top side of said hollow case and comprising a first terminal set formed thereon ; and
a second positioning set extending from an inner bottom side of said hollow case and comprising a second terminal sets formed thereon.

2. A connector adaptor suitable for various transmission protocols accordingly to claim 1, wherein said hollow case comprises fool-proof grooves formed respectively on two sides thereof.

3. A connector adaptor suitable for various transmission protocols accordingly to claim 1, wherein said hollow case comprises a hollow portion.

4. A connector adaptor suitable for various transmission protocols accordingly to claim 1, wherein said hollow case is connected to a clamp formed at a bottom portion thereof.

5. (canceled)

6. A connector adaptor suitable for various transmission protocols accordingly to claim 1, wherein one of said first and second terminal sets comprises fixed flat terminals, and other terminal comprises movable hook shaped terminals.

7. A connector adaptor suitable for various transmission protocols accordingly to claim 1, wherein said first and second terminal sets comprise movable hook shaped terminals or fixed flat terminals.

8. A connector adaptor suitable for various transmission protocols accordingly to claim 1, wherein said first and second terminal sets respectively comprise a plurality of eSATA terminals serving as an eSATA terminal set, and a plurality of USB terminals serving as a USB terminal set.

9. A connector adaptor suitable for various transmission protocols, comprising:
a hollow case, comprising two positioning sets respectively extending an inner top side and an inner bottom side thereof, and a terminal set formed on said positioning sets respectively, wherein said terminal sets are respectively disposed installed on a flat face of said positioning sets; and
a housing, covering said hollow case.

10. A connector adaptor suitable for various transmission protocols accordingly to claim 9, wherein said housing is one-piece formed by a metallic stamping process.

11. A connector adaptor suitable for various transmission protocols accordingly to claim 9, wherein said housing comprises an upper stopper, a lower stopper and two short stoppers surrounding a frontal end thereof.

12. A connector adaptor suitable for various transmission protocols accordingly to claim 9, wherein said housing comprises a plurality of pins.
